(19) United States
(12) Patent Application Publication
(10) Pub. No.: US 2008/0160128 A1
(43) Pub. Date: Jul. 3, 2008

(54) Food processor implement

(75) Inventors: Eli Cohen, Lev HaSharon (IL); Ann Grant, New York, NY (US)

Correspondence Address: Martin D. Moynihan;PRTSI, Inc., P.O. Box 16446, Arlington, VA, 22215, US

(73) Assignee: AAC Trade Ltd., New York, NY (US)

(21) Appl. No.: 11/647,254

(22) Filed: Dec. 29, 2006

(51) Int. Cl. B29C 47/58; A23P 1/12

(52) U.S. Cl. 425/296

(57) ABSTRACT

A food processor implement for converting food articles into a stringy nature, includes: a base; a die member mounted on the base and formed with a plurality of die openings; a pusher member mounted on the base in spaced relation to the die member to define a space between the two members for receiving the food article to be processed; and a drive for driving one of the members towards the other after the food article has been received in the space between the two members, to force the food article through the plurality of die openings, and thereby to convert the food article to a stringy nature. In the described preferred embodiment, the die member is fixed to the base, and the pusher member is manually driven towards the die member.

### FIELD AND BACKGROUND OF THE INVENTION

The present invention relates to food processor implements for converting food articles into various forms. More particularly, the present invention relates to a simple, manually-driven food processor implement for converting food articles, such as potatoes, onions, apples, and almost any other type of food or vegetable, into a stringy nature, i.e. into the form of strings, strands, ribbons or the like.

Various types of food processor implements are known for converting food articles into various forms, such as for cutting, slicing, shredding, etc. the food article. The present invention is based on the appreciation that converting various types of food articles, such as potatoes, onions, apples, and many other types of fruits and vegetables, into a stringy form, e.g. in the form of strings, strands, ribbons, etc. may not only make the food article easier to eat and to digest, but may also make the food article more appetizing in appearance.

### OBJECT AND BRIEF SUMMARY OF THE INVENTION

An object of the present invention is to provide a food processor implement which may be used for converting various types of food articles, particularly potatoes, onions, apples, and many other fruits and vegetables, into a stringy form for the above purposes.

According to a broad aspect of the present invention, there is provided a food processor implement for converting food articles into a stringy form, comprising: a base for supporting the implement on a flat horizontal surface; a die member mounted on the base and formed with a plurality of die openings; a pusher member mounted on the base in spaced relation to the die member to define a space between the two members for receiving the food article to be processed; and a drive for driving one of the members towards the other of the members, after the food article has been received in the space between the two members, to force the food article through the plurality of die openings, and thereby to convert the food article to a stringy form.

According to further features in the described preferred embodiment, the die member is fixed to the base, and the pusher member is driven by the drive towards the die member. More particularly, the pusher member is slidably mounted on the base between a pair of posts carried by the base.

According to still further features in the described preferred embodiment, the drive is a manual drive. It includes a drive lever pivotally mounted at a mid-portion thereof, the drive lever having one end which is manually engageable to pivot the drive lever, and an opposite end effective to move the pusher member when the drive lever is manually pivoted.

More particularly, the mid-portion of the drive lever is pivotally mounted to a mid portion of an arm, which arm is pivotally mounted at one end to the base on the side of the pusher member opposite to the die member. The arm is spring-urged to a position spacing the pivotal mounting of the drive lever above the base.

According to still further important features in the described preferred embodiment, the end of the arm opposite to that of its pivotal mounting carries a manually-engageable element which is manually depressible to move the pivotal mounting of the drive lever towards the base, and thereby to increase the force of the final movement of the pusher member towards the die member. The manually-engageable end of the drive lever is in the form of a handle graspable by the user, and the manually-engageable element carried by the arm is in the form of an enlarged head manually depressible by the user.

As will be described more particularly below, a food processor implement may be constructed in accordance with the foregoing features to provide a simple, portable, manually-driven device for converting food articles into a stringy form.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is an isometric view illustrating one form of food processor implement constructed in accordance with the present invention;

FIG. 2 is a view similar to that of FIG. 1, but illustrating the die member detached from the implement;

FIG. 3 is a top plan view of the food processor implement of FIG. 1;

FIG. 4 is a bottom plan view of the food processor implement of FIG. 1;

FIGS. 5 and 6 are end views, from the opposite ends, of the implement of FIG. 1;

FIG. 7 is a side elevational view of the food processor implement of FIG. 1, the implement being shown in its initial condition for receiving a food article;

FIG. 8 is a view similar to that of FIG. 7, but showing the implement in its actuated condition wherein it has converted the food article into a stringy form;

FIG. 9 is a sectional view along line A-A of FIG. 8;

FIG. 10 illustrates the die member and its mounting fame;

FIG. 11 illustrates the mounting plate for the pusher member; and

FIGS. 12 and 13 illustrate the opposite faces of the pusher member mounted by the mounting plate of FIG. 11.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF A PREFERRED EMBODIMENT

As indicated earlier, the food processor implement of the present invention is an implement for converting food articles into a stringy form, e.g., strings, strands, ribbons or the like. The food articles may be potatoes, onions, apples, and many other types of fruits and vegetables. The stringy form of the food article has been found to increase not only the digestibility of the food article, but also its capability of promoting interest in the food article and the appetite of a person viewing the food article.

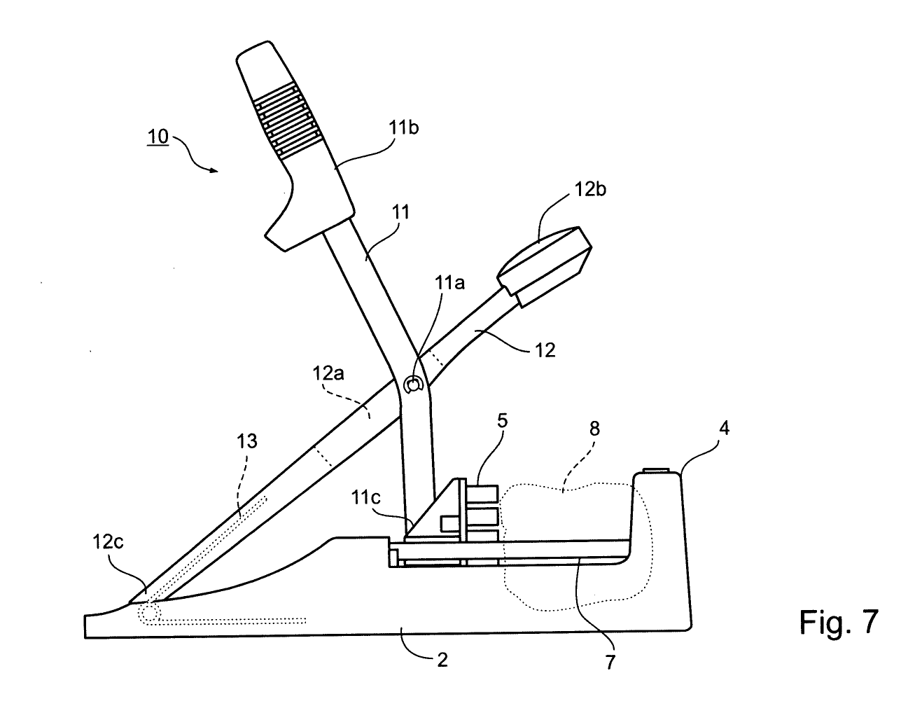

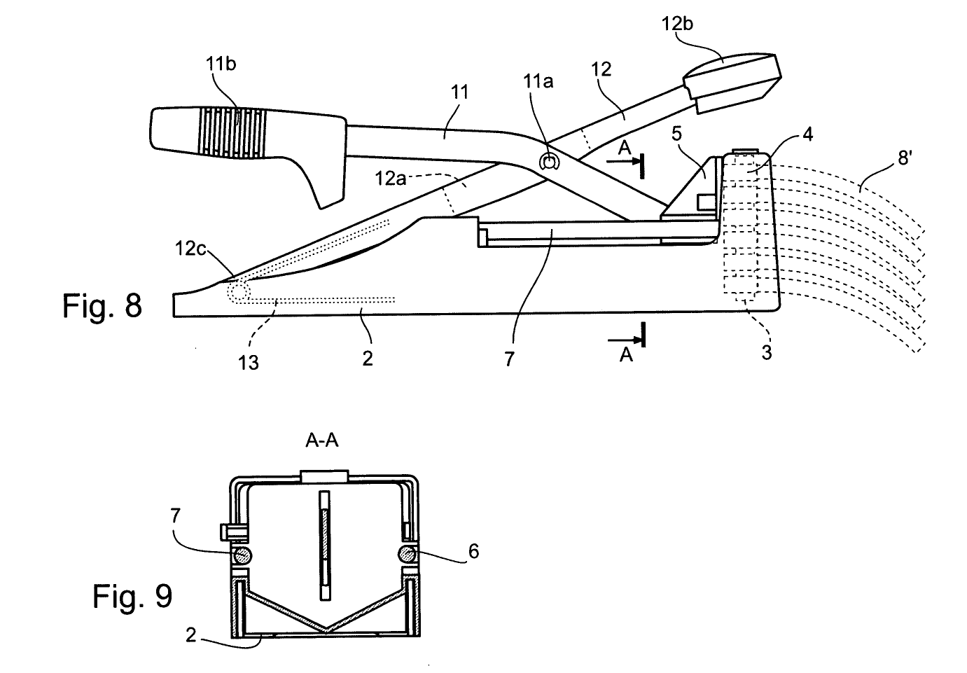

The food processor implement illustrated in the drawings, as a preferred embodiment of the invention, includes a base 2 for supporting the implement on a flat horizontal surface, a die member 3 mounted within a frame 4 fixed at one end of the base, and a pusher member 5 movably mounted between a pair of posts 6, 7, towards and away from die member 3. Pusher member 5 is normally located spaced from die member 3 and its frame 4, to define a space for receiving the food article to be processed, schematically shown at 8 in FIG. 7. After the food article 8 has been introduced into the space between the die member 3 and pusher member 5, the pusher member is driven by a manual drive, schematically shown at 10, towards the die member to force the food article through the plurality of die openings in die member 3, and thereby to convert the food article into a stringy form, as shown at 8′ in FIG. 8.

As shown particularly in FIGS. 7 and 8, manual drive 10 includes a drive lever 11 pivotally mounted at a mid-portion thereof 11a to an arm 12. One end of drive lever 11 carries a manually-graspable handle 11b, and its opposite end 11c is pivotally coupled to pusher member 5.

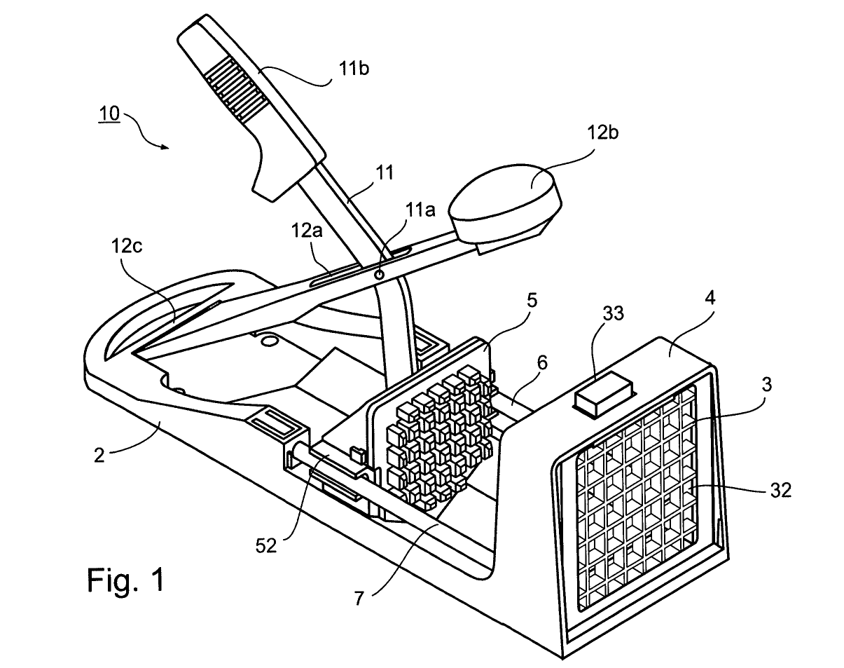

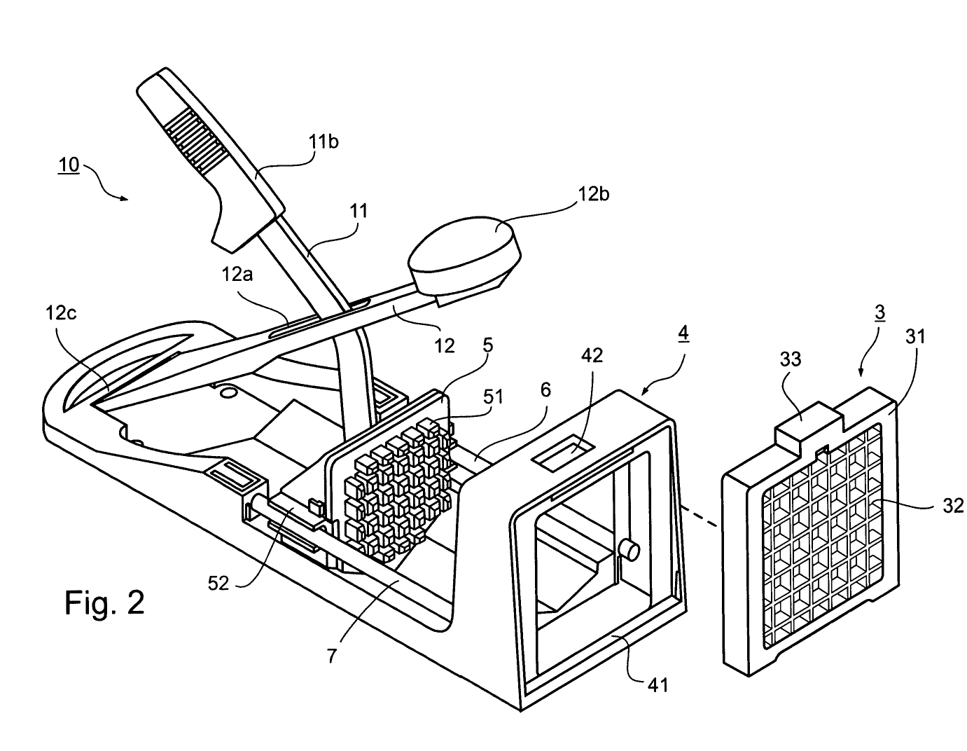

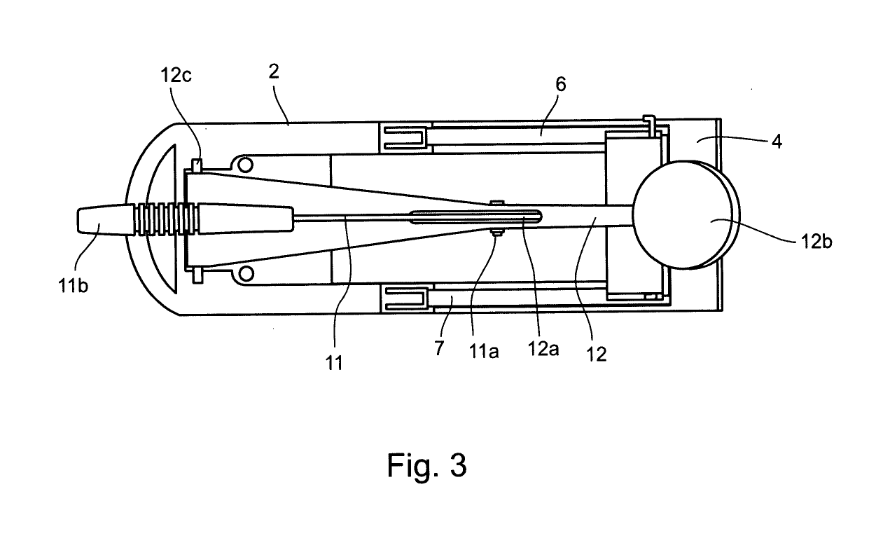

As best seen in FIGS. 1 and 2 as well as in FIGS. 7 and 8, arm 12 is formed at a mid-portion thereof with a slot 12a for accommodating the portions of drive lever 11 on opposite sides of its pivotal mounting 11a. One end of arm 12 is free and includes an enlarged head 12b, whereas the opposite end is pivotally mounted to base 2, as shown at 12c. A piano spring 13 urges arm 12 to its normal position as shown in FIG. 7.

The structure of die member 3, together with its mounting frame 4, is best illustrated in FIG. 2. As shown therein, die member 3 is of rectangular configuration, including a rectangular frame 31 circumscribing a plurality of die openings 32, also of rectangular configuration. Die openings 32 are arranged according to a rectangular matrix of a plurality of horizontal rows and vertical columns. In the example illustrated, die member 3 includes seven horizontal rows and seven vertical columns of square openings 32.

Die member 3 is further formed with a tab 33 projecting upwardly from its upper frame edge. Tab 33 is provided to facilitate the attachment of die member 3 to its frame 4.

The inner surface of frame 4 is formed with a stepped seat 41 for receiving die member 3. Its upper surface is formed with an opening 42 of the same configuration as tab 33 of the die member, for releasably retaining the die member within the frame.

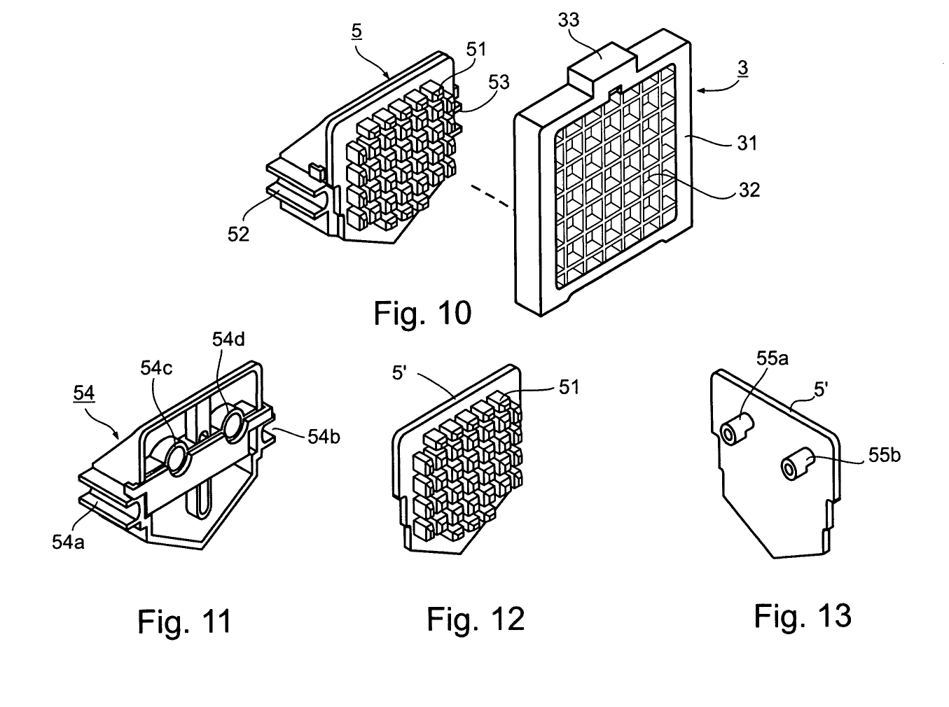

Pusher member 5 is best seen in FIG. 10. One face of the pusher member is formed with a plurality of ribs or projections 51 for firmly engaging the food article to be processed. Preferably, projections 51 are of the same configuration as the openings 31 in die member 3 and are arranged according to the same rectangular matrix. Pusher member 5 further includes a pair of die tubular guides 52, 53 on its opposite sides, for receiving the tubular posts 6, 7 of base 2, and thereby for guiding the movement of pusher member 5 towards and away from die member 3.

FIGS. 11-13 illustrate a modification in the construction of the pusher member, therein generally designated 5′, to facilitate its removal for cleaning purposes. FIG. 11 illustrates a mounting plate, therein generally designated 54, for mounting pusher member 5′. FIGS. 12 and 13 illustrate the opposite faces of pusher member 5′.

Thus, as shown in FIG. 11, mounting plate 54 is formed with the tubular guides 54a, 54b, for slidably receiving the tubular posts, 6, 7 of the base 2. Mounting plate 54 is further formed with a pair of sockets 54c, 54d, for receiving, with a friction fit, tubular pins 55a, 55b formed in the confronting surface of pusher member 5′, as shown in FIG. 13. Such a construction permits convenient removal of pusher member 5′ for cleaning purposes.

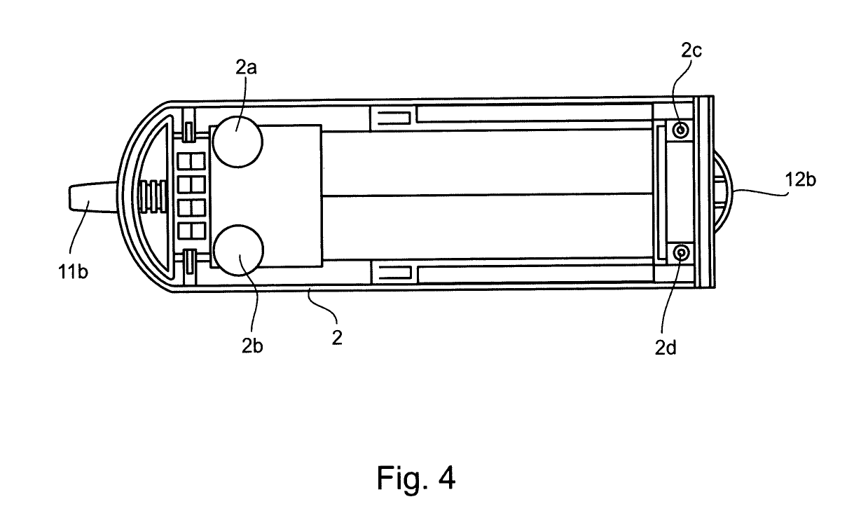

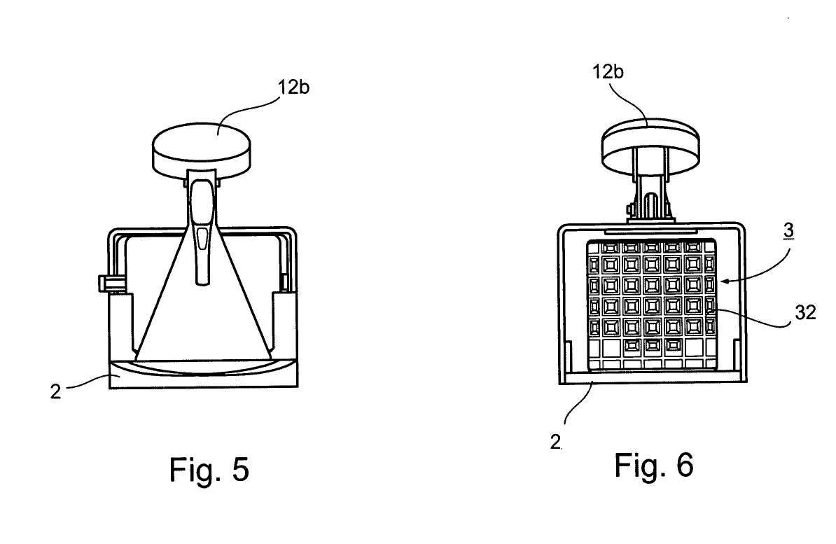

As shown in FIG. 4, base 2 is formed with a pair of feet 2a, 2b on one end, and a second pair of feet 2c, 2d at the opposite end, to stably support the implement on a flat horizontal surface.

The manner of using the food processor implement illustrated in the drawings will be apparent from the above description. FIG. 1 illustrates the implement in its normal condition, wherein pusher member 5 is spaced from die member 3 to allow the introduction of the food article 8 (FIG. 7) between the two members. Handle 11b of drive lever 11 is then grasped by one hand and moved downwardly. This moves pusher member 5 towards die member 3, and thereby forces the food article through the openings in the die member, as shown in FIG. 8, to convert the food articles into a stringy form as shown at 8′. This downward movement of drive lever 11 also pivots arm 12 downwardly, thereby lowering the pivotal mounting 11a of drive lever 11. Towards the end of this downward movement of drive lever 11, enlarged head 12b of arm 12 may be engaged by the hand of the user and pressed downwardly, to thereby increase the force of the final movement of pusher member 5 towards die member 3.

While the invention has been described with respect to one preferred embodiment, it will be appreciated that this is set forth merely for purposes of example, and that many other variations, modifications and applications of the invention may be made.

What is claimed is:

1. A food processor implement for converting food articles into a stringy form, comprising:
a base for supporting the implement on a flat horizontal surface;
a die member mounted on said base and formed with a plurality of die openings;
a pusher member mounted on said base in spaced relation to said die member to define a space between the two members for receiving the food article to be processed;
and a drive for driving one of said members towards the other of said members, after the food article has been received in said space between the two members, to force the food article through said plurality of die openings, and thereby to convert the food article to a stringy form.

2. The food processor implement according to claim 1, wherein said die member is fixed to said base, and said pusher member is driven by said drive towards said die member.

3. The food processor implement according to claim 2, wherein said pusher member is slidably mounted on said base between a pair of posts carried by said base.

4. The food processor implement according to claim 1, wherein said drive is a manual drive.

5. The food processor implement according to claim 4, wherein said manual drive includes a drive lever pivotally mounted at a mid-portion thereof, said drive lever having one end which is manually engageable to pivot the drive lever, and an opposite end effective to move said pusher member towards said die member when said drive lever is manually pivoted.

6. The food processor implement according to claim 5, wherein said mid-portion of said drive lever is pivotally mounted to a mid-portion of an arm, which arm is pivotally mounted at one end to said base on the side of said pusher member opposite to said die member.

7. The food processor implement according to claim 6, wherein said arm is spring-urged to a position spacing said pivotal mounting of the drive lever above said base.

8. The food processor implement according to claim 6, wherein the end of said arm opposite to that of its pivotal mounting carries a manually-engageable element which is manually depressible to move said pivotal mounting of the drive lever towards said base, and thereby to increase the force of the final movement of the pusher member towards said die member.

9. The food processor implement according to claim 8, wherein said manually-engageable end of said drive lever is in the form of a handle graspable by the user, and said manually-engageable element carried by said arm is in the form of an enlarged head manually depressible by the user.

10. The food processor implement according to claim 8, wherein said die member is fixed at one end of said base, and said arm is pivotally mounted at the opposite end of said base.

11. The food processor implement according to claim 1, wherein said die member is removably attachable to a frame fixed to said base.

12. The food processor implement according to claim 11, wherein said frame is fixed to one end of said base.

13. The food processor implement according to claim 11, wherein said die member includes a projecting tab receivable within a hole formed in said frame to permit the attachment of the die member to said frame in a removable manner.

14. The food processor implement according to claim 11, wherein said frame and said die member are of rectangular configuration, and said plurality of openings formed in the die member are arranged according to a rectangular matrix in horizontal rows and vertical columns.

15. The food processor implement according to claim 14, wherein said plurality of openings in said die member are each of rectangular configuration.

16. The food processor implement according to claim 1, wherein said pusher member is removably attached to a mounting plate movably mounted on said base.

17. The food processor implement according to claim 16, wherein said pusher member includes a face formed with a plurality of projections for firmly gripping the food article when driving the food article towards the die member.

18. The food processor implement according to claim 16, wherein said mounting plate is slidably mounted with respect to said base by a pair of posts carried by said base and extending longitudinally thereof.

19. The food processor implement according to claim 16, wherein said pusher member is removably attached to said mounting plate by a plurality of sockets formed on one receiving with a friction fit a plurality of pins carried by the other.

20. The food processor implement according to claim 19, wherein said mounting plate is formed with said plurality of sockets, and said pusher member carries said plurality of pins.
